(19) United States
(12) Patent Application Publication
(10) Pub. No.: US 2026/0005274 A1
(43) Pub. Date: Jan. 1, 2026

(54) POWER PLANT SYSTEMS AND METHODS OF OPERATION ASSOCIATED WITH VARIED HYDROGEN PURITY

(71) Applicant: HYAXIOM, INC., East Hartford, CT (US)

(72) Inventors: Catherine Pratt, Holyoke, MA (US); Jayson Mills, Kailua, HI (US); Justin Webster, Mansfield Center, CT (US); David Barth, Northborough, MA (US)

(21) Appl. No.: 18/758,579

(22) Filed: Jun. 28, 2024

(51) Int. Cl. H01M 8/04746; H01M 8/04082; H01M 8/04089; H01M 8/0444; H01M 8/086; H01M 8/10; H01M 8/2457

(52) U.S. Cl. CPC H01M 8/04753; H01M 8/04097; H01M 8/04201; H01M 8/04447; H01M 8/2457; H01M 8/086; H01M 8/10; H01M 2008/1095

(57) ABSTRACT

A system for generating power may include a fuel cell stack including one or more hydrogen fuel cells. The system may be operated in one or more modes based on a hydrogen purity of fuel supplied to the stack. A method of operating a fuel cell stack is also disclosed.

### BACKGROUND

This disclosure relates to power generation, and more particularly hydrogen fuel cells and methods of operation.

Naturally occurring geological hydrogen is an available carbon-free fuel source. It is present in a gaseous mixture along with other species such as nitrogen. The content of hydrogen in the gas can vary and may be considered low purity in comparison to hydrogen that may be used for fuel in hydrogen fuel cells. Purification of geological hydrogen can be costly. Phosphoric acid fuel cells (PAFC) may be designed to operate with high purity hydrogen or a high hydrogen content reformate. Hydrogen concentrations of 99.9 percent or greater may be required to operate the fuel cell.

### SUMMARY

A system for generating power may include a fuel cell stack including one or more hydrogen fuel cells and a fuel delivery assembly. The fuel delivery assembly may include a fuel inlet path including an inlet section and a supply section that may be interconnected by a pump. The inlet section may be adapted to receive fuel from a fuel source. The supply section may be adapted to deliver fuel from the inlet section to an inlet of the fuel cell stack. The fuel delivery assembly may include a supply augmentation path including an augmentation valve that may selectively interconnect the inlet section and the supply section such that fuel from the inlet section of the fuel inlet path may bypass the pump. A controller may include one or more processors and memory. The controller may be operable to cause the fuel delivery assembly to operate in a first mode in response to a hydrogen concentration of fuel in the fuel inlet path meeting a preselected concentration threshold, which may include causing the augmentation valve to block flow through the supply augmentation path. The controller may be operable to cause the fuel delivery assembly to operate in a second mode in response to the hydrogen concentration being below the preselected concentration threshold, which may include causing the augmentation valve to communicate flow through the supply augmentation path to deliver additional fuel to the inlet of the fuel cell stack.

A controller for a hydrogen power plant may include one or more processors and memory. The one or more processors may be collectively operable to receive, from a hydrogen concentration sensor, an indication of hydrogen concentration of fuel in a fuel inlet path. The fuel inlet path may be adapted to deliver fuel from a fuel source to an inlet of a hydrogen fuel cell stack interconnected by a pump. The one or more processors may be collectively operable to cause an augmentation valve to block flow of fuel through a supply augmentation path in response to a hydrogen concentration of fuel in the fuel inlet path meeting a preselected concentration threshold, but may cause the augmentation valve to communicate flow through the supply augmentation path in response to the hydrogen concentration being below the preselected concentration threshold such that additional fuel may be delivered to the inlet of the fuel cell stack by bypassing the pump in the fuel inlet path.

A method of operating a hydrogen fuel cell stack for generating power may include determining a hydrogen concentration of fuel from a fuel source. The method may include delivering, with a pump, a portion of the fuel from the fuel source to an inlet of a hydrogen fuel cell stack. The method may include blocking flow of the fuel through a supply augmentation path in response to the determined hydrogen concentration meeting a preselected concentration threshold, but may include communicating a portion of the fuel through the supply augmentation path in response to the determined hydrogen concentration being below the preselected concentration threshold such that additional fuel may be delivered from the fuel source to the inlet of the fuel cell stack by bypassing the pump.

Various features and advantages of at least one disclosed example embodiment will become apparent to those skilled in the art from the following detailed description. The drawing that accompanies the detailed description can be briefly described as follows.

### BRIEF DESCRIPTION OF THE DRAWING

FIG. 1 is a view of fuel cells in a fuel cell stack.

FIG. 2 is a perspective view of the fuel cell stack shown in FIG. 1.

FIG. 3 discloses a system including a fuel stack coupled to a fuel source.

FIG. 4 discloses a system including a fuel stack coupled to a fuel source according to another implementation.

FIG. 5 discloses a method for operating a fuel cell stack.

Like reference numbers and designations in the various drawings indicate like elements.

### DETAILED DESCRIPTION

Hydrogen power plant systems designed according to the techniques disclosed herein may be useful for generating electricity that can be used for a variety of purposes separate from the system itself. The disclosed (e.g., power plant) system may include one or more phosphoric acid fuel cells (PAFC) that may be adapted to produce power and/or heat from hydrogen fuels having variable hydrogen content (e.g., purity or concentration). The system may be adapted to operate with hydrogen purities as low as 80 percent, or even as low as 60 percent purity or less.

The system may be adapted to operate in different operating modes based on a concentration (e.g., purity) of hydrogen delivered from a fuel source. The disclosed system may control the flow of fuel based on real time measured hydrogen concentration. The system may be adapted to switch between a first (e.g., recycle or high purity) mode for high purity and a second (e.g., single pass, bypass or low purity) mode for relatively low purity. In the single pass mode, fuel may pass once through the fuel cell stack and may be exhausted from an anode outlet without being returned to an anode inlet of the fuel cell(s). Unused fuel from the anode outlet may returned to the anode inlet in the recycle mode. The recycle mode may maximize or otherwise improve efficiency by recycling unused hydrogen. The fuel cell may have a derated capability when operating in the single pass with relatively low purity hydrogen fuel.

The system may be adapted to operate in the recycle mode when the hydrogen concentration of the delivered fuel meets a preselected concentration threshold, but may operate in the single pass mode when the hydrogen concentration is below the preselected concentration threshold. The first mode may be associated with a relatively high purity hydrogen fuel. The second mode may be associated with a relatively low purity hydrogen fuel. The system may include a delivery pump operable to increase or otherwise set a volumetric flow rate of the fuel in the single pass mode to deliver a sufficient amount of hydrogen to the fuel cell(s).

A system for generating power may include a fuel cell stack including one or more hydrogen fuel cells and a fuel delivery assembly. The fuel delivery assembly may include a fuel inlet path including an inlet section and a supply section that may be interconnected by a pump. The inlet section may be adapted to receive fuel from a fuel source. The supply section may be adapted to deliver fuel from the inlet section to an inlet of the fuel cell stack. The fuel delivery assembly may include a supply augmentation path including an augmentation valve that may selectively interconnect the inlet section and the supply section such that fuel from the inlet section of the fuel inlet path may bypass the pump. A controller may include one or more processors and memory. The controller may be operable to cause the fuel delivery assembly to operate in a first mode in response to a hydrogen concentration of fuel in the fuel inlet path meeting a preselected concentration threshold, which may include causing the augmentation valve to block flow through the supply augmentation path. The controller may be operable to cause the fuel delivery assembly to operate in a second mode in response to the hydrogen concentration being below the preselected concentration threshold, which may include causing the augmentation valve to communicate flow through the supply augmentation path to deliver additional fuel to the inlet of the fuel cell stack.

In any implementations, the pump may be an ejector.

In any implementations, the pump may include a first inlet and a second inlet. The first inlet may be coupled to the inlet section of the fuel inlet path. The fuel delivery assembly may include a recycling control valve in a fuel recycling path between an outlet of the fuel cell stack and the second inlet. The controller may be operable to cause the recycling control valve to interconnect the outlet of the fuel cell stack and the second inlet of the pump to communicate flow of fuel through the fuel recycling path in the first mode, but not in the second mode.

In any implementations, the pump may be an ejector including a first inlet coupled to the inlet section of the fuel inlet path and an outlet coupled to the supply section of the fuel inlet path.

In any implementations, the ejector may include a second inlet operable to receive fuel from a fuel recycling path coupled to an outlet of the fuel cell stack.

In any implementations, a hydrogen concentration sensor may be coupled to the controller. The hydrogen concentration sensor may be operable to determine a hydrogen concentration of fuel in the fuel inlet path.

In any implementations, the preselected concentration threshold may be equal to or greater than 95 percent pure hydrogen.

In any implementations, the fuel may include geological hydrogen.

In any implementations, the one or more fuel cells may include one or more phosphoric acid fuel cells (PAFC).

In any implementations, the one or more fuel cells include one or more polymer electrolyte membrane (PEM) fuel cells.

A controller for a hydrogen power plant may include one or more processors and memory. The one or more processors may be collectively operable to receive, from a hydrogen concentration sensor, an indication of hydrogen concentration of fuel in a fuel inlet path. The fuel inlet path may be adapted to deliver fuel from a fuel source to an inlet of a hydrogen fuel cell stack interconnected by a pump. The one or more processors may be collectively operable to cause an augmentation valve to block flow of fuel through a supply augmentation path in response to a hydrogen concentration of fuel in the fuel inlet path meeting a preselected concentration threshold, but may cause the augmentation valve to communicate flow through the supply augmentation path in response to the hydrogen concentration being below the preselected concentration threshold such that additional fuel may be delivered to the inlet of the fuel cell stack by bypassing the pump in the fuel inlet path.

In any implementations, the pump may be an ejector.

In any implementations, the one or more processors may be collectively operable to cause a recycling control valve to communicate fuel from an outlet of the fuel cell stack to an inlet of the pump in response to the hydrogen concentration meeting the preselected concentration threshold, but may cause the recycling control valve to block flow of fuel from the outlet of the fuel cell stack to the inlet of the pump in response to the hydrogen concentration being below the preselected concentration threshold.

In any implementations, the pump may be an ejector including a first inlet coupled to the fuel source, a second inlet coupled to the outlet of the fuel cell stack, and an outlet coupled to the inlet of the fuel cell stack. The ejector may be configured such that flow through the first inlet may serve as a motive stream for conveying flow from the second inlet to the outlet of the ejector. The supply augmentation path may selectively interconnect the first inlet and the outlet of the ejector in response to opening the augmentation valve.

A method of operating a hydrogen fuel cell stack for generating power may include determining a hydrogen concentration of fuel from a fuel source. The method may include delivering, with a pump, a portion of the fuel from the fuel source to an inlet of a hydrogen fuel cell stack. The method may include blocking flow of the fuel through a supply augmentation path in response to the determined hydrogen concentration meeting a preselected concentration threshold, but may include communicating a portion of the fuel through the supply augmentation path in response to the determined hydrogen concentration being below the preselected concentration threshold such that additional fuel may be delivered from the fuel source to the inlet of the fuel cell stack by bypassing the pump.

In any implementations, the pump may be an ejector.

In any implementations, the method may include blocking flow of unspent fuel from an outlet of the fuel cell stack to the pump in response to the determined hydrogen concentration being below the preselected concentration threshold, but may include communicating a portion of the unspent fuel from the outlet of the fuel cell stack to the pump in response to the determined hydrogen concentration meeting the preselected concentration threshold such that the portion of unspent fuel may be joined with the flow of fuel from the fuel source to deliver a combined fuel to the inlet of the fuel cell stack.

In any implementations, the method may include setting a flow rate of fuel from the fuel source to the pump based on the determined hydrogen concentration.

In any implementations, the fuel cell stack may include one or more phosphoric acid fuel cells (PAFC).

In any implementations, the fuel from the fuel source may include geological hydrogen.

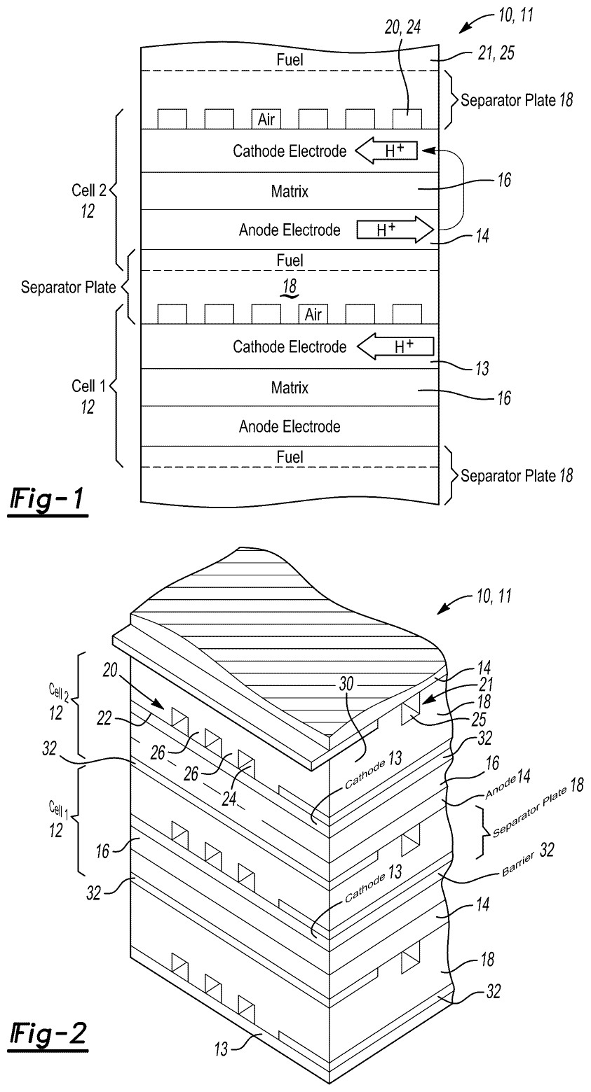

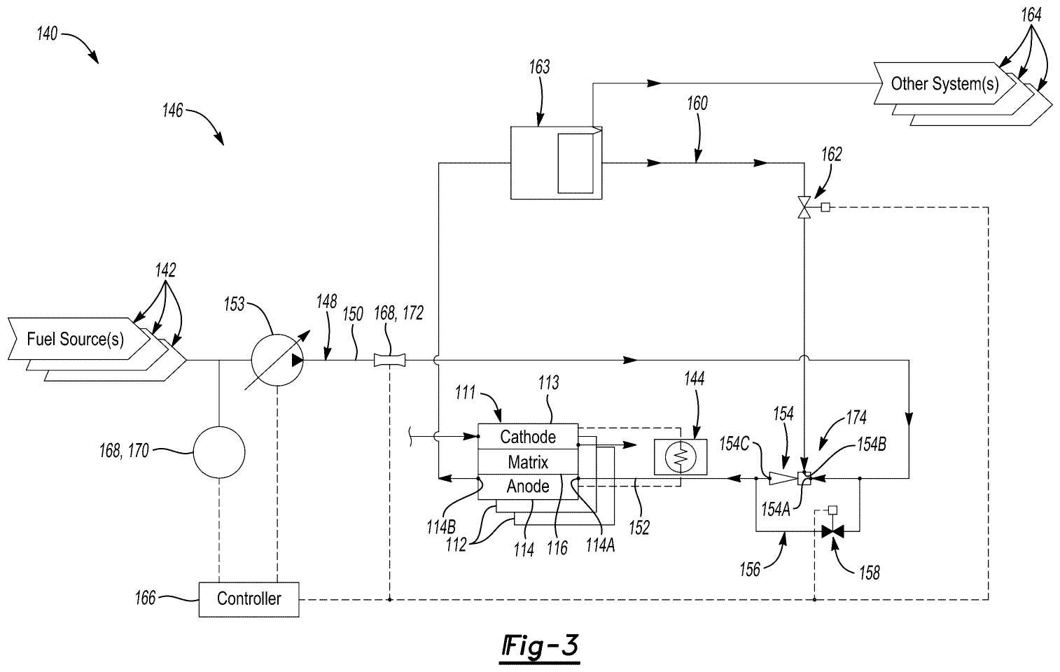

FIGS. 1-2 disclose an electrochemical system 10 according to an implementation. The electrochemical system 10 may include one or more fuel cells 12. A plurality of the cells 12 may be arranged in a fuel cell stack 11. The stack 11 may be a sub-stack that may be incorporated in multiple sub-stacks of a larger stack. The fuel cell 12 may be a phosphoric acid fuel cell (PAFC) or a polymer electrolyte membrane (PEM) fuel cell. Each fuel cell 12 may include a cathode electrode 13 and an anode electrode 14. The fuel cell stack 11 may include a first fuel cell 12 (“Cell 1”) and an adjoining second cell 12 (“Cell 2”). Each fuel cell 12 may include a matrix 16. The matrix 16 may contain a solid or liquid acid electrolyte. The matrix 16 may serve as a membrane.

A separator plate 18 may be positioned between the cathode electrode 13 of one cell 12 (e.g., Cell 1) and the anode electrode 14 of an adjacent cell 12 (e.g., cell 2). Each separator plate 18 may define a first flow field 20, such as a cathode flow field, adjacent a first contact surface 22 of the separator plate 18 (FIG. 2). The first flow field 20 may include one or more flow channels 24 defined between adjacent ribs 26 of the separator plate 18. The flow channel 24 may extend inwardly from the first contact surface 22. The first contact surface 22 may contact the adjacent cathode electrode 13 to direct an oxidant reactant stream adjacent the cathode electrode 13. The separator plate 18 may define a second flow field 21, such as an anode flow field. The second flow field 21 may include one or more one flow channels 25. The flow channel 25 may be adapted to direct a hydrogen reactant stream (e.g., fuel) adjacent the anode electrode 14. In implementations, the flow fields 20, 21 of adjacent cells 12 may be established by a single, bipolar plate that may also serve as the separator plate 18 between the adjacent cells 12. The bipolar plates may be coupled to a (e.g., direct current) power source for inducing a current across the cell 12. A barrier (e.g., seal) 32 may extend along an edge 30 of the separator plate 18.

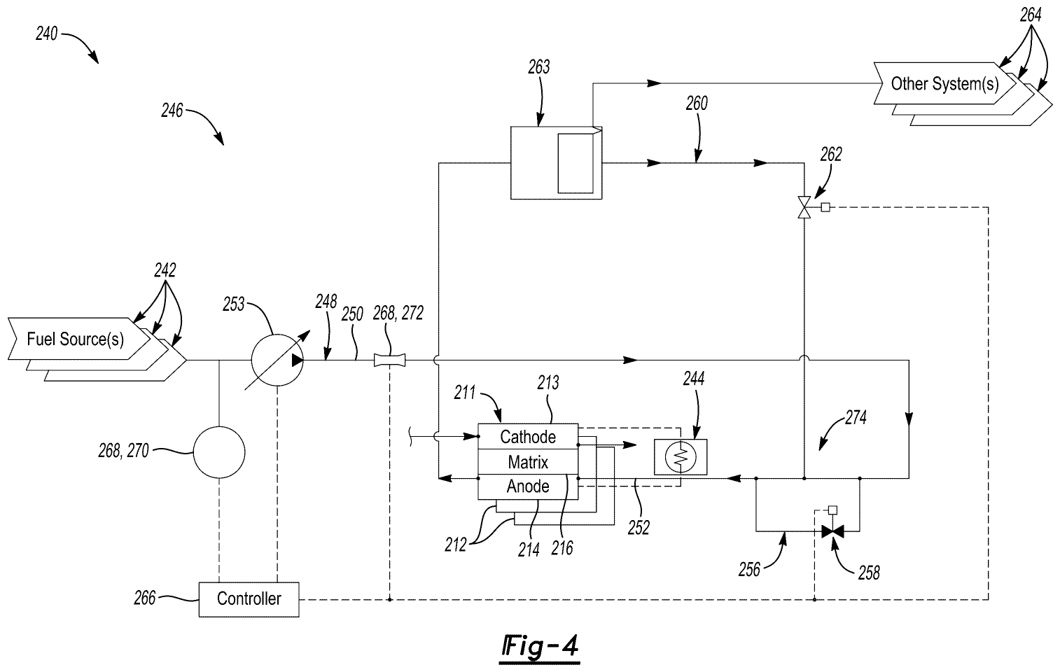

FIG. 3 discloses a (e.g., power plant) system 140 for generating power and/or heat. In implementations, the system 140 may be a hydrogen power plant. In this disclosure, like reference numerals designate like elements where appropriate and reference numerals with the addition of one-hundred or multiples thereof designate modified elements that are understood to incorporate the same features and benefits of the corresponding original elements. The system 140 may include one or more hydrogen fuel cells 112. The fuel cells 112 may be arranged in one or more fuel cell stacks 111. The fuel cell 112 may a phosphoric acid fuel cell (PAFC) or polymer electrolyte membrane (PEM) fuel cell.

Each of the fuel cells 112 may include a cathode 113 and an anode 114 on opposite sides of a matrix 116. The cathode 113 may be adapted to generate exhaust in the form of water (H₂O) and unused oxygen (O). The anode 114 may be adapted to generate exhaust in the form of unused hydrogen (H₂), which may be recycled in a fuel stream to the stack 111.

Each stack 111 and/or fuel cell 112 may be coupled to one or more fuel source(s) 142. The fuel source 142 may include one or more containers and may be adapted to convey fuel such as hydrogen to the stack(s) 111. The fuel may include hydrogen.

The system 140 may be adapted to operate utilizing fuels having different hydrogen purity levels and/or mixed fuel from two or more fuel sources (e.g., byproduct of a chemical plant). In implementations, the fuel may include geological hydrogen. For the purposes of this disclosure, the term “geological hydrogen” means naturally occurring hydrogen gas generated by various geological processes. The geological processes may generate hydrogen gas from water. Geological hydrogen may be found in its natural form beneath the Earth's surface. A purity of geological hydrogen may vary depending on the geological source. In implementations, the system 140 may exclude any reformers for supplying hydrogen fuel to the stack(s) 111.

Each stack 111 may be coupled to one or more (e.g., customer) loads 144. Each load 144 may be an electrical and/or thermal load. The stack 111 may be configured to supply electricity and/or heat in a fluid stream to the load 144. The system 120 may include an inverter that may be configured to convert DC power from the stack(s) 111 into AC power on the grid. The AC power may be communicated to the load(s) 144.

The system 140 may include a fuel delivery assembly 146 adapted to deliver or otherwise communicate fuel from the fuel source 142 to the fuel cell stack(s) 111 and/or associated fuel cell(s) 112. Each anode 114 may include an anode inlet 114A and an anode outlet 114B. The fuel delivery assembly 146 may be adapted to communicate fuel to a manifold of the stack 111 for distribution to the anode inlets 114A.

The fuel delivery assembly 146 may include one or more fluid paths, such as a fuel inlet path 148, which may be coupled to the fuel source 142. The fuel inlet path 148 may be adapted to deliver fuel from the fuel source 142 to the inlet of the fuel cell stack(s) 111 and/or anode inlet(s) 114A of the fuel cell(s) 112. The fuel inlet path 148 may include an inlet section 150 and/or a supply section 152. The inlet section 150 may be adapted to receive fuel from the fuel source 142. The supply section 152 may be adapted to deliver fuel from the inlet section 150 to an inlet of the fuel cell stack(s) 111 and/or fuel cell(s) 112.

The fuel delivery assembly 146 may include a delivery pump 153 adapted to convey fuel from the fuel source 142. The delivery pump 153 may be situated in the inlet section 150 of the fuel inlet path 148. In implementations, the delivery pump 153 may be a variable speed pump. In other implementations, the fuel source 142 may be adapted to convey pressurized fuel to the system 140.

The inlet section 150 and supply section 152 of the fuel inlet path 148 may be interconnected by a pump (e.g., recirculator) 154. Various pumps and other flow distribution devices may be utilized. The pump 154 may be an ejector. In other implementations, the pump 154 may be a recirculation blower. The pump 154 may be arranged at a junction 174. The pump 154 may include a first (e.g., primary) inlet 154A and an outlet 154C. The first inlet 154A may be coupled to the inlet section 150 of the fuel inlet path 148. The outlet 154C may be coupled to the supply section 152 of the fuel inlet path 148. In implementations, the pump 154 may include a second (e.g., secondary) inlet 154B. In implementations in which the pump 154 may be an ejector, the pump 154 may be configured such that flow through the first inlet 154A may serve as a motive stream for conveying flow from the second inlet 154B to the outlet 154C of the pump 154.

The fuel delivery assembly 146 may include a supply augmentation path 156 may be adapted to deliver (e.g., additional) fuel to the inlet of the stack(s) 111 and/or fuel cell(s) 112. The supply augmentation path 156 may include an augmentation valve 158, which may be adapted to meter flow through the supply augmentation path 156. The supply augmentation path 156 may selectively interconnect the first inlet 154A and the outlet 154C of the pump 154 in response to opening the augmentation valve 158. The augmentation valve 158 may be adapted to selectively interconnect the inlet section 150 and the supply section 152 of the fuel inlet path 148 such that fuel from the inlet section 150 of the fuel inlet path 148 may bypass the pump 154. In other implementations, the pump 154 may be sized based on the fuel content and/or flow rate such that the supply augmentation path 156 may be omitted.

The fuel delivery assembly 146 may include a fuel recycling path 160. The fuel recycling path 160 may be established between an outlet of the fuel cell stack(s) 111 and/or fuel cell(s) 112 and the second inlet 154B of the pump 154. The outlet of the stack 111 may be associated with the outlet(s) 114B of the anode(s) 114. The outlet of the stack 111 may be an anode outlet 114B or may be a manifold that may interconnect two or more anode outlets 114B. The second inlet 154B of the pump 154 may be operable to receive unused hydrogen fuel from the fuel recycling path 160. The fuel delivery assembly 146 may include a recycling control valve 162 in the fuel recycling path 160. The recycling control valve 162 may be adapted to meter flow through the fuel recycling path 160. The recycling control valve 162 may be adapted to selectively interconnect the outlet of the fuel cell stack(s) 111 and/or fuel cell(s) 112 and the second inlet 154B of the pump 154 to recirculate unused hydrogen from the anode outlet(s) 114B to the anode inlet(s) 114A associated with the outlet and inlet of the stack 111.

A conditioning device (e.g., acid scrubber) 163 may be disposed in the fuel recycling path 160. The acid scrubber 163 may be adapted to condition unused fuel including hydrogen from the fuel cell(s) 12 and communicate the conditioned unused fuel to other (e.g., customer) system(s) 164 and/or back through the fuel recycling path 160 to the inlet of the stack(s) 111.

The system 140 may include a controller 166. The controller 166 may be operable to control one or more devices of a system, such as a hydrogen power plant. The controller 166 may include one or more analog and/or digital components. The controller 166 may include one or more processors, memory and/or interfaces. The processor(s) may be any type of known processor or microprocessor having desired performance characteristics. The memory may include UVPROM, EEPROM, FLASH, RAM, ROM, DVD, CD, a hard drive, or other computer readable medium which may store data and the method 380 (FIG. 5) for operation of the controller 166. The processor(s) of the controller 166 may be collectively operable to execute one or more instructions to implement any of the functionality disclosed herein.

The controller 166 may be coupled to, and may be operable to modulate or otherwise control, one or more devices including the pump 153, valve 158 and/or valve 162. The controller 166 may be coupled to one or more sensors 168. The controller 166 may be operable to receive information including one or more sensed conditions from the sensor(s) 168. The sensors 168 may include a hydrogen concentration sensor 170 and/or flow meter 172. The hydrogen concentration sensor 170 may be operable to measure or otherwise determine a hydrogen concentration of fuel in the fuel inlet path 148. The controller 166 may be operable to receive, from the hydrogen concentration sensor 170, an indication of the hydrogen concentration of fuel in the fuel inlet path 148 and/or at the fuel source(s) 142. The system 140 may include one or more sensors operable to determine impurities such as carbon monoxide (CO) in the fuel. In implementations in which the fuel cell(s) 112 may be a PEM fuel cell, the system 140 may include a carbon monoxide (CO) sensor operable to determine a presence and/or amount of CO in the fuel supplied to the fuel cell(s) 112.

The flow meter 172 may be operable to measure or otherwise determine a rate of flow of fuel through the fuel inlet path 148. The controller 166 may be operable to receive, from the flow meter 172, an indication of the rate of flow of fuel through the fuel inlet path 148. The controller 166 may be operable to modulate the valves 158 and/or 162 based on the sensor information. The controller 166 may be operable to access one or more lookup tables and/or parametric relationships to set the position of the valves 158, 162 based on the sensor information.

The system 140 may be coupled to two or more fuel sources 142. The controller 166 may be operable to select between the fuel sources 142 for delivery of fuel to the fuel cell(s) 112.

The controller 166 may be operable to cause the fuel delivery assembly 146, fuel stack(s) 111 and/or fuel cell(s) 112 to operate in one or more operating modes based on a concentration (e.g., purity) of hydrogen in the fuel delivered by the fuel source 142.

The controller 166 may be operable to block operation of the fuel cell(s) 112 and/or associated stack(s) 111 unless the hydrogen concentration of fuel in the fuel inlet path 148 meets a minimum concentration threshold. In implementations, the minimum concentration threshold may be equal to or greater than about 60 percent pure hydrogen, or more narrowly may be equal to or greater than about 80 percent pure hydrogen.

The controller 166 may be operable to cause the fuel delivery assembly 146 to operate in a first (e.g., recycle or high purity) mode in response to the hydrogen concentration of fuel in the fuel inlet path 148 meeting a preselected concentration threshold. The preselected concentration threshold may be equal to or greater than about 90 percent pure hydrogen, or more narrowly may be equal to or greater than about 95 percent pure hydrogen. In implementations, the preselected concentration threshold may be equal to or greater than about 99.9 percent pure hydrogen.

The controller 166 may be operable to cause the fuel delivery assembly 146 to operate in the recycle mode in response to the determined hydrogen concentration in the fuel inlet path 148 meeting the preselected concentration threshold. The controller 166 may be operable to cause the augmentation valve 158 to block flow through the supply augmentation path 156 in the recycle mode.

The controller 166 may be operable to cause the fuel delivery assembly 146 to operate in a second (e.g., single pass, bypass, or low purity) mode in response to the determined hydrogen concentration being below the preselected concentration threshold. The controller 166 may be operable to cause the augmentation valve 158 to communicate flow through the supply augmentation path 156 in the single pass mode such that additional fuel may be delivered to the inlet of the fuel cell stack(s) 111 and/or anode inlet(s) 114A of the fuel cell(s) 112. Flow through the supply augmentation path 156 may bypass the pump 154 in the fuel inlet path 148.

Each fuel cell 112 may be associated with a (e.g., preselected) hydrogen supply threshold. The hydrogen supply threshold may be an amount of hydrogen sufficient to operate the hydrogen fuel cell 112 to generate power without physical degradation. Physical degradation may occur due to starvation and/or various impurities that may be present in the fuel. The fuel cell 112 may require a relatively higher volume of low purity fuel for operation than for a relatively high purity fuel. A sufficient amount of fuel may ensure that substantially all active parts of the fuel cell 112 may receive hydrogen.

The controller 166 may be operable to modulate the delivery pump 153 based on a determined volumetric flow rate through the flow meter 172 and/or the hydrogen concentration determined by the hydrogen concentration sensor 170. The controller 166 may be operable to cause the delivery pump 153 to increase or otherwise set a volumetric flow rate of the fuel in the single pass mode to deliver a sufficient amount of hydrogen to the fuel cell(s) 112 of the respective fuel cell stack(s) 111.

The controller 166 may be operable to cause the recycling control valve 162 to interconnect the outlet of the fuel cell stack(s) 111 and/or anode inlet(s) 114A of the fuel cell(s) 112 and the second inlet 154B of the pump 154 to communicate flow of fuel through the fuel recycling path 160 in the recycle mode, but not in the single pass mode. The controller 166 may be operable to cause the recycling control valve 162 to communicate fuel from the outlet of the fuel cell stack(s) 111 and/or anode outlet(s) 114B of the fuel cell(s) 112 to the second inlet 154B of the pump 154 in response to the hydrogen concentration meeting the preselected concentration threshold. The controller 166 may be operable to cause the recycling control valve 162 to block flow through the fuel recycling path 160 in the single pass mode. The controller 166 may be operable to cause the recycling control valve 162 to block flow of fuel from the outlet of the fuel cell stack(s) 111 and/or anode outlet(s) 114B of the fuel cell(s) 112 to the inlet 154B of the pump 154 in response to the hydrogen concentration being below the preselected concentration threshold.

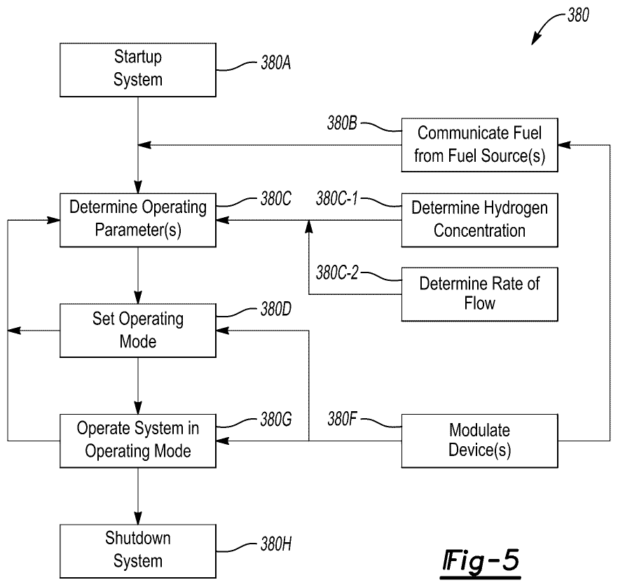

FIG. 4 discloses a system 240 including a fuel delivery assembly 246 according to another implementation. The fuel delivery assembly 246 may be adapted to deliver or otherwise communicate fuel from fuel source(s) 242 to one or more fuel cell stacks 211 and/or fuel cells 212. In the implementation of FIG. 4, the pump 154 of FIG. 3 may be omitted. The fuel delivery assembly 246 includes a T-junction 274 adapted to join an inlet section 250 of a fuel inlet path 248 and a fuel recycling path 260 with a supply section 252 of the fuel inlet path 248. The fuel delivery assembly 246 includes a supply augmentation path 256. The supply augmentation path 256 may be adapted to cause a portion of fuel in the inlet section 250 of the fuel inlet path 248 to bypass the T-junction 274 in response to opening an augmentation valve 258. The controller 266 may be operable to modulate the augmentation valve 258 utilizing any of the techniques disclosed herein.

FIG. 5 discloses a method of operating hydrogen fuel cell stack(s) and/or fuel cell(s) in a flowchart 380 according to an implementation. The fuel stack may include any of the fuel stacks disclosed herein, such as the fuel stacks 11, 111, 211. In implementations, the fuel cell stack may include one or more phosphoric acid fuel cells (PAFC). Fewer or additional steps than are recited below could be performed within the scope of this disclosure, and the recited order of steps is not intended to limit this disclosure. The controller 166/266 may be operable to perform any of the functionality of the method 380. Reference is made to the system 140 of FIG. 3, although the method 380 may also be utilized to operate the system 240 of FIG. 4.

At block 380A the system 140 may enter into a startup mode. At block 380B, fuel may be delivered or otherwise communicated from one or more fuel sources 142, including any of the fuel sources disclosed herein. The fuel may include various levels of hydrogen concentration (e.g., purity). In implementations, at least a majority or substantially all of the supplied fuel may be geological hydrogen. For the purposes of this disclosure, the terms “about” and “substantially” mean+10 percent of the stated value or relationship unless otherwise indicated.

At block 380C, one or more operating parameters associated with the system 140 may be determined, including any of the parameters disclosed herein. Block 380C may include determining a hydrogen concentration of the fuel from the respective fuel source 142 at block 380C-1. The hydrogen concentration may be measured or otherwise determined by the hydrogen concentration sensor 170. Block 380C may include determining a rate of flow of the fuel through the fuel inlet path 148 at block 380C-2. The rate of flow may be measured or otherwise determined by the flow meter 172.

At block 380D, the operating mode of the system 140 may be changed or otherwise set. The system 140 may be associated with at least two operating modes, including any of the modes disclosed herein. The operating modes may include a first (e.g., recycle or high purity) mode and a second (e.g., single pass, bypass, or low purity) mode. The system 140 may operate in the recycle mode when the hydrogen concentration of the delivered fuel meets a preselected concentration threshold, but may operate in the single pass mode when the hydrogen concentration is below the preselected concentration threshold. The recycle mode may be associated with a relatively high purity hydrogen fuel. The single pass mode may be associated with a relatively low purity hydrogen fuel. In implementations, the operating mode may be (e.g., dynamically) changed during operation of the system 140 based on the operating parameter(s) determined at block 380C.

Block 380D may include blocking operation of the fuel cell(s) 112 and/or associated stack(s) 111 in the first mode and/or the second mode unless the determined hydrogen concentration meets a minimum concentration threshold. The minimum concentration threshold may include any of the values disclosed herein.

At block 380E, the system 240 may operate in the operating mode set at block 380D. Block 380E may include delivering, with the pump 154, a portion of the fuel from the fuel source 142 to an inlet of the fuel cell stack 11 and/or the anode inlet(s) 114A of the respective fuel cell(s) 112. In implementations, the pump 154 may be an ejector.

At block 380F, one or more devices may be modulated to control a flow of fuel through the system 140, including the fuel delivery assembly 146. Block 380F may occur during block 380D and/or block 380E. Block 380F may include setting a flow rate of fuel from the fuel source(s) 142 to the pump 154 based on the determined hydrogen concentration. Block 380F may include controlling a flow rate of the pump 153 such that a preselected amount of hydrogen is delivered to the fuel cell stack 111 and/or respective fuel cell(s) 112. The pump 153 may be controlled based on the determined flow rate and/or hydrogen concentration of fuel in the fuel inlet path 148. The preselected amount of hydrogen may be an amount sufficient to operate the fuel cell stack(s) 111 and/or respective fuel cell(s) 112 in the selected operating mode without physical degradation.

Block 38OF may include blocking flow of fuel through the supply augmentation path 156 in response to the determined hydrogen concentration meeting the preselected concentration threshold, but communicating a portion of the fuel through the supply augmentation path 156 in response to the determined hydrogen concentration being below the preselected concentration threshold such that (e.g., additional) fuel may be delivered from the fuel source 142 to the inlet of the fuel cell stack(s) 111 and/or the anode inlet(s) 114A of the respective fuel cell(s) 112 by bypassing the pump 154.

Block 380F may include blocking flow of unused (e.g., unspent) hydrogen fuel from the outlet of the fuel cell stack(s) 111 and/or the anode outlet(s) 114B of the respective fuel cell(s) 112 to the pump 154 in response to the determined hydrogen concentration being below the preselected concentration threshold, but communicating a portion of the unspent fuel from the outlet of the fuel cell stack(s) 111 and/or the anode outlet(s) 114B of the fuel cell(s) 112 to the pump 154 in response to the determined hydrogen concentration meeting the preselected concentration threshold such that the portion of unspent fuel may be joined with the flow of fuel from the fuel source 142 through the inlet section 150 of the fuel inlet path 148 to deliver a combined fuel to the inlet of the fuel cell stack(s) 111 and/or the anode inlet(s) 114A of the fuel cell(s) 112.

Method 380 may include repeating one or more iterations of any of blocks 380B to 380G. At block 380H, the system 140 may enter a shutdown mode. Block 380H may include stopping flow of fuel from the fuel source(s) 142.

The novel devices and methods of this disclosure provide flexibility for using the system with fuels of various hydrogen purity. The disclosed techniques may avoid use of a processing unit (e.g., cleanup skid) for processing geological hydrogen, which may reduce cost and system complexity. The processing unit may be operable to remove impurities in the fuel which may be poisonous to the fuel cell. The system may be adapted to switch between the single pass mode for low purity and the recycle mode for high purity to maximize or otherwise improve efficiency. The mode may be set at startup and/or may be (e.g., dynamically) adjusted or otherwise set during operation based on the determined hydrogen concentration. Utilizing the techniques disclosed herein, the system may generate power and/or heat from geological hydrogen without incorporating a purification system to bring hydrogen concentrations to a relatively high level (e.g., 99.9 percent).

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should further be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed:

1. A system for generating power comprising:
a fuel cell stack including one or more hydrogen fuel cells;
a fuel delivery assembly comprising:
a fuel inlet path including an inlet section and a supply section interconnected by a pump, wherein the inlet section is adapted to receive fuel from a fuel source, and the supply section is adapted to deliver fuel from the inlet section to an inlet of the fuel cell stack; and
a supply augmentation path including an augmentation valve that selectively interconnects the inlet section and the supply section such that fuel from the inlet section of the fuel inlet path bypasses the pump; and
a controller including one or more processors and memory, wherein the controller is operable to:
cause the fuel delivery assembly to operate in a first mode in response to a hydrogen concentration of fuel in the fuel inlet path meeting a preselected concentration threshold, including causing the augmentation valve to block flow through the supply augmentation path; and
cause the fuel delivery assembly to operate in a second mode in response to the hydrogen concentration being below the preselected concentration threshold, including causing the augmentation valve to communicate flow through the supply augmentation path to deliver additional fuel to the inlet of the fuel cell stack.

2. The system as recited in claim 1, wherein the pump is an ejector.

3. The system as recited in claim 1, wherein:
the pump includes a first inlet and a second inlet;
the first inlet is coupled to the inlet section of the fuel inlet path;
the fuel delivery assembly includes a recycling control valve in a fuel recycling path between an outlet of the fuel cell stack and the second inlet; and
the controller is operable to cause the recycling control valve to interconnect the outlet of the fuel cell stack and the second inlet of the pump to communicate flow of fuel through the fuel recycling path in the first mode, but not in the second mode.

4. The system as recited in claim 1, wherein the pump is an ejector including a first inlet coupled to the inlet section of the fuel inlet path and an outlet coupled to the supply section of the fuel inlet path.

5. The system as recited in claim 4, wherein the ejector includes a second inlet operable to receive fuel from a fuel recycling path coupled to an outlet of the fuel cell stack.

6. The system as recited in claim 1, further comprising:
a hydrogen concentration sensor coupled to the controller, wherein the hydrogen concentration sensor is operable to determine a hydrogen concentration of fuel in the fuel inlet path.

7. The system as recited in claim 6, wherein the preselected concentration threshold is equal to or greater than about 95 percent pure hydrogen.

8. The system as recited in claim 1, wherein the fuel includes geological hydrogen.

9. The system as recited in claim 1, wherein the one or more fuel cells include one or more phosphoric acid fuel cells (PAFC).

10. The system as recited in claim 1, wherein the one or more fuel cells include one or more polymer electrolyte membrane (PEM) fuel cells.

11. A controller for a hydrogen power plant comprising:
one or more processors and memory;
wherein the one or more processors are collectively operable to:
receive, from a hydrogen concentration sensor, an indication of hydrogen concentration of fuel in a fuel inlet path, the fuel inlet path adapted to deliver fuel from a fuel source to an inlet of a hydrogen fuel cell stack interconnected by a pump; and
cause an augmentation valve to block flow of fuel through a supply augmentation path in response to a hydrogen concentration of fuel in the fuel inlet path meeting a preselected concentration threshold, but cause the augmentation valve to communicate flow through the supply augmentation path in response to the hydrogen concentration being below the preselected concentration threshold such that additional fuel is delivered to the inlet of the fuel cell stack by bypassing the pump in the fuel inlet path.

12. The controller as recited in claim 11, wherein the pump is an ejector.

13. The controller as recited in claim 11, wherein the one or more processors are collectively operable to:
cause a recycling control valve to communicate fuel from an outlet of the fuel cell stack to an inlet of the pump in response to the hydrogen concentration meeting the preselected concentration threshold, but cause the recycling control valve to block flow of fuel from the outlet of the fuel cell stack to the inlet of the pump in response to the hydrogen concentration being below the preselected concentration threshold.

14. The controller as recited in claim 13, wherein:
the pump is an ejector including a first inlet coupled to the fuel source, a second inlet coupled to the outlet of the fuel cell stack, and an outlet coupled to the inlet of the fuel cell stack;
the ejector is configured such that flow through the first inlet serves as a motive stream for conveying flow from the second inlet to the outlet of the ejector; and
the supply augmentation path selectively interconnects the first inlet and the outlet of the ejector in response to opening the augmentation valve.

15. A method of operating a hydrogen fuel cell stack for generating power comprising:
determining a hydrogen concentration of fuel from a fuel source;
delivering, with a pump, a portion of the fuel from the fuel source to an inlet of a hydrogen fuel cell stack; and
blocking flow of the fuel through a supply augmentation path in response to the determined hydrogen concentration meeting a preselected concentration threshold, but communicating a portion of the fuel through the supply augmentation path in response to the determined hydrogen concentration being below the preselected concentration threshold such that additional fuel is delivered from the fuel source to the inlet of the fuel cell stack by bypassing the pump.

16. The method as recited in claim 15, wherein the pump is an ejector.

17. The method as recited in claim 16, further comprising:
blocking flow of unspent fuel from an outlet of the fuel cell stack to the pump in response to the determined hydrogen concentration being below the preselected concentration threshold, but communicating a portion of the unspent fuel from the outlet of the fuel cell stack to the pump in response to the determined hydrogen concentration meeting the preselected concentration threshold such that the portion of unspent fuel is joined with the flow of fuel from the fuel source to deliver a combined fuel to the inlet of the fuel cell stack.

18. The method as recited in claim 16, further comprising:
setting a flow rate of fuel from the fuel source to the pump based on the determined hydrogen concentration.

19. The method as recited in claim 16, wherein the fuel cell stack includes one or more phosphoric acid fuel cells (PAFC).

20. The method as recited in claim 15, wherein the fuel from the fuel source includes geological hydrogen.
